(19) United States
(12) Patent Application Publication
(10) Pub. No.: US 2010/0225133 A1
(43) Pub. Date: Sep. 9, 2010

(54) HOISTING SYSTEM FOR RESCUE OPERATIONS

(76) Inventors: Mark Ferrara, Breaux Bridge, LA (US); Monica Ferrara, Breaux Bridge, LA (US)

Correspondence Address: LAW OFFICE OF JERRY D. HAYNES , P.A, P.O. Box 350392, Fort Lauderdale, FL, 33335, US

(21) Appl. No.: 12/399,112

(22) Filed: Mar. 6, 2009

(51) Int. Cl. B66C 1/00

(52) U.S. Cl. 294/68.1

(57) ABSTRACT

A hoisting system is adapted to be configured on an emergency vehicle for rescue operations to save one or more victims. The hoisting system comprises at least one retractable arrangement, a deck member, and a locking mechanism. The at least one retractable arrangement comprises a hollow telescopic member, and a winch member including a cable of predetermined length wound thereto. The hollow telescopic member is capable of extending and contracting longitudinally. The cable is capable of being unwound from the winch member for passing through the hollow telescopic member. The deck member is adapted to be coupled to an end portion of the cable unwound from the winch member. The deck member is capable of moving downwardly upon unwinding of the cable, and moving upwardly upon winding of the cable. The locking mechanism is configured on the at least one retractable arrangement for locking a spinning of the deck member.

### FIELD OF THE INVENTION

The present invention relates generally to lifesaving systems, and more particularly, to a hoisting system adapted to be configured on an emergency vehicle for rescue operations to save victims, such as persons trapped in burning buildings, floods, forest fires, and the like.

### BACKGROUND OF THE INVENTION

Lifesaving systems are utilized for rescue operations to save victims, such as persons trapped in burning buildings, floods, forest fires, and the like. Generally, a lifesaving system is operable in conjunction with an emergency vehicle, such as a ship, a boat, a helicopter, and a land vehicle such as a crane. Particularly, the lifesaving systems may be configured on such emergency vehicle, and further may be operated from the emergency vehicle for the rescue operations at sites, such as burning buildings, floods, forest fires, and the like.

Various types of lifesaving systems are available for rescue operations in order to save the victims. Majority of previously available lifesaving systems used in such rescue operations are designed to support weight of small number of people, such as, one person at a time. Due to such limitation of supporting limited weight, the previously available lifesaving systems may not offer an efficient and successful rescue of more than one person at a time.

Further, the previously available lifesaving systems, generally, include cable arrangement, and a platform deck attached thereto. The cable arrangement may descend the platform deck at the rescue sites so that a person may climb the platform deck to rest thereon. Furthermore, the cable arrangement may ascend the platform deck to rescue the person resting on the platform deck. More often than not, due to undistributed weight of the person on the platform deck, and lifting action, the platform deck may spin, which may result in falling of the person resting thereon.

Accordingly, there exists a need for rescuing one or more victims at a time, in an efficient and a successful manner. Further, there exits a need for precluding a falling of a person due to spinning and lifting action in previously available lifesaving systems.

### SUMMARY OF THE INVENTION

In view of the foregoing disadvantages inherent in the prior art, the general purpose of the present invention is to provide a hoisting system for rescue operations, to include all advantages of the prior art, and to overcome the drawbacks inherent in the prior art.

An object of the present invention is to rescue one or more victims at a time, in an efficient and a successful manner.

Another object of the present invention is to preclude a falling of a person due to spinning and lifting action.

To achieve the above objects, in an aspect of the present invention, a hoisting system is provided. The hoisting system is adapted to be configured on an emergency vehicle for rescue operations to save one or more victims. The hoisting system comprises at least one retractable arrangement, a deck member, and a locking mechanism. The at least one retractable arrangement is adapted to be configured on a portion of the emergency vehicle. The at least one retractable arrangement comprises a hollow telescopic member, and a winch member. The hollow telescopic member is capable of extending and contracting longitudinally. The winch member includes a cable of predetermined length wound thereto. The cable is capable of being unwound from the winch member for passing through the hollow telescopic member. The cable is unwound from the winch member to extend longitudinally downward through the hollow telescopic member. Further, the cable is wound on the winch member to contract longitudinally upward through the hollow telescopic member. Furthermore, the deck member is capable of supporting the one or more victims thereon. The deck member is adapted to be coupled to an end portion of the cable unwound from the winch member. The deck member is capable of moving downwardly upon unwinding of the cable, and is capable of moving upwardly upon winding of the cable. Moreover, the locking mechanism is configured on the at least one retractable arrangement for locking a spinning of the deck member coupled to the end portion of the cable.

The hoisting system is capable of rescuing one or more victims at a time, in efficient and successful manner. The one or more victims may be persons trapped in burning buildings, floods, forest fires, and the like. Further, the locking mechanism configured on the at least one retractable arrangement preclude the spinning of the deck member, which may spin due to undistributed weight thereon and lifting action thereof, to avoid falling of the one or more victims.

This together with the other aspects of the present invention, along with the various features of novelty that characterized the present invention, is pointed out with particularity in the claims annexed hereto and forms a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1A illustrates a perspective view of a hoisting system configured on an emergency vehicle for a rescue operation on a site, in accordance with an exemplary embodiment of the present invention;

FIG. 1B illustrates a bottom view of the emergency vehicle of FIG. 1A, in accordance with an exemplary embodiment of the present invention;

FIGS. 2A and 2B illustrate a front view of a portion of the hoisting system of FIG. 1A, in accordance with an exemplary embodiment of the present invention;

FIG. 3 illustrates a perspective view of a portion of a hoisting system, in accordance with another exemplary embodiment of the present invention;

FIGS. 4A and 4B illustrate top views of a deck member of the portion of the hoisting system of FIG. 3, in accordance with another exemplary embodiment of the present invention; and

FIG. 5 illustrates a side view of the portion of the hoisting system of FIG. 4 for being utilized in a rescue operation on a site, in accordance with an exemplary embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “coupled,” and variations thereof herein are used broadly and encompass direct and indirect couplings.

The terms, “first,” “second,” “top,” “bottom,” and the like, herein do not denote any order, elevation or importance, but rather are used to distinguish placement of one element over another. Further, the terms, “a” and “an” herein do not denote a limitation of quantity, but rather denote the presence of at least one of the referenced item.

The term “emergency vehicle” used herein, includes but not limited to, a helicopter, a ship, a boat, and a land vehicle such as a crane.

The present invention provides a hoisting system for rescue operations to save life of one or more victims at a time, trapped in burning buildings, floods, forest fires, and the like. The hoisting system offers rescuing of the trapped victims in an efficient and a successful manner. Further, the hoisting system precludes a spinning action of a deck member due to undistributed weight of victims thereon and lifting action to avoid falling of the one or more victims.

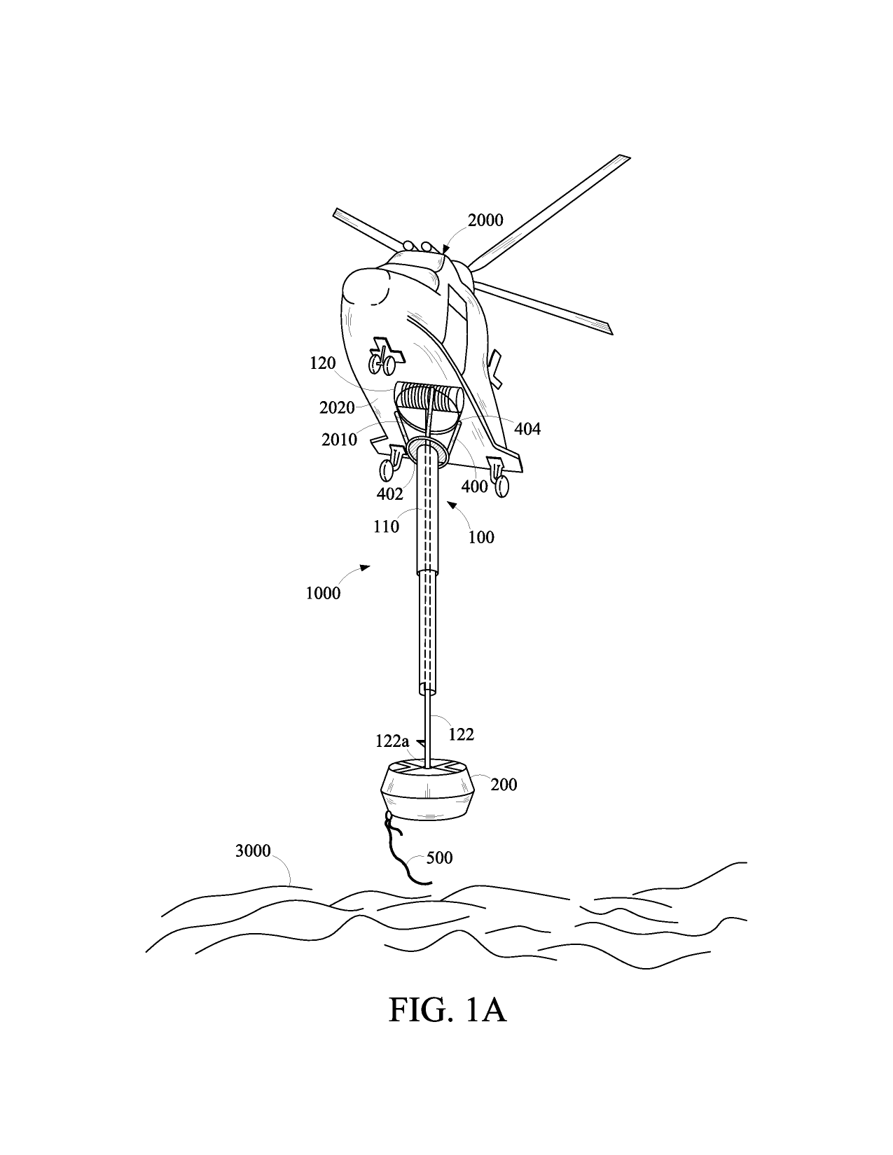

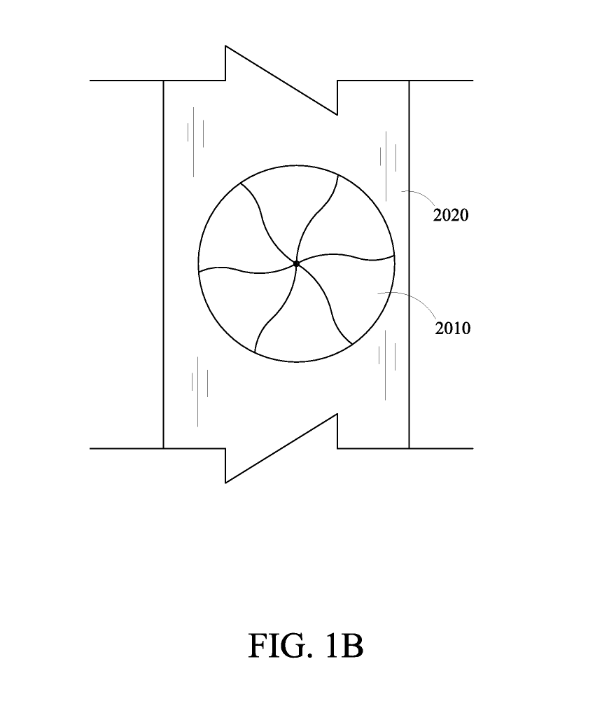

Referring now to FIGS. 1A and 1B, a hoisting system 1000 configured on an emergency vehicle 2000 for a rescue operation on a site, is illustrated, according to an exemplary embodiment of the present invention. Particularly, FIG. 1A illustrates a perspective view of the hoisting system 1000 configured on the emergency vehicle 2000 for a rescue operation on the site. Further, FIG. 1B illustrates a bottom view of the emergency vehicle 2000 of FIG. 1A on which the hoisting system 1000 is configured for being utilized in the rescue operation. The site as shown in FIG. 1A is a region affected by flood (herein after referred to as ‘flood region 3000’), however, it will be evident to a person skilled in the art to utilize the hoisting system 1000 for other sites, such as a region affected by fire, like burning buildings and/or burning forests. Further, the emergency vehicle 2000 as shown is FIG. 1A is a helicopter, however, it will be evident for a person skilled in the art to utilize a hoisting system, such as the hoisting system 1000, in conjunction with other emergency vehicle, such as a ship, a boat, and a land vehicle such as a crane.

The hoisting system 1000 is adapted to be configured on the emergency vehicle 2000 for rescue operations to save one or more victims. More particularly, the emergency vehicle 2000 may include a space door 2010 configured on a base 2020 of the emergency vehicle 2000. The space door 2010 may be opened and closed for utilizing the hoisting system 1000. In FIG. 1A, the space door 2010 is at open position, and in FIG. 1B, the space door 2010 is at closed position. The hoisting system 1000 may be configured on the base 2020 adjacent to the space door 2010 for an efficient and a successful rescue operation in order to save the one or more victims trapped on the site, such as the flood region 3000.

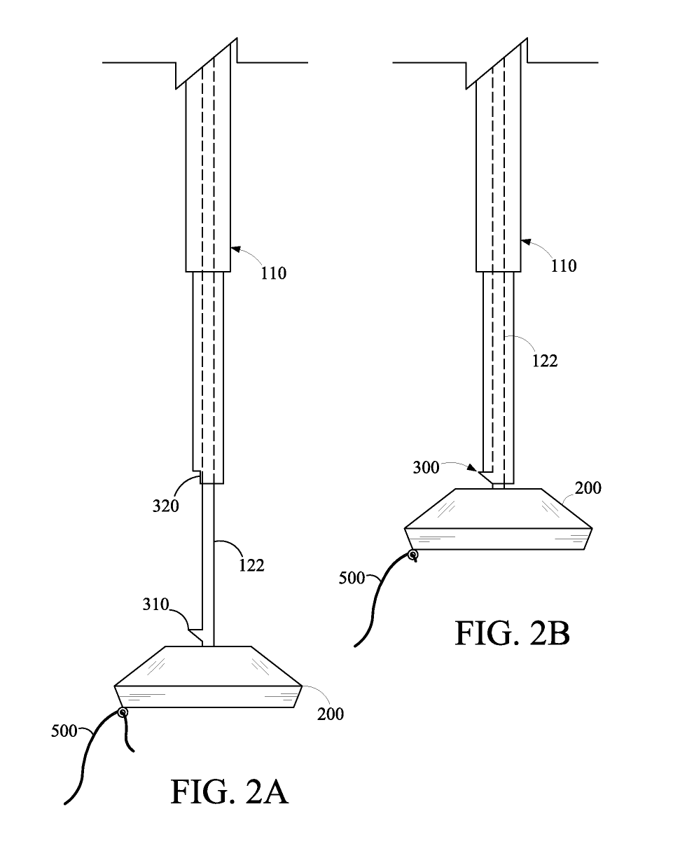

More particularly, the hoisting system 1000 includes at least one retractable arrangement 100, a deck member 200, and a locking mechanism 300 (shown in FIG. 2B). The at least one retractable arrangement 100 includes a hollow telescopic member 110 and a winch member 120. Further, the winch member 120 includes a cable 122 of a predetermined length wound on the winch member 120. The predetermined length of the cable 122 may depend upon a distance between the emergency vehicle 2000 and a site on which a rescue operation is to be carried. The hollow telescopic member 110 may be configured at a bottom surface of the base 2020 of the emergency vehicle 2000, such that the hollow telescopic member 110 is aligned to the space door 2010. The hollow telescopic member 110 may be configured to the bottom surface of the base 2020 by a supporting structure 400. The supporting structure 400 includes a first end portion 402 and a second end portion 404. The hollow telescopic member 110 may be coupled to the first end portion 402 of the supporting structure 400. Further, the second end portion 404 of the supporting structure 400 may be coupled to the bottom surface of the base 2020, thereby coupling the hollow telescopic member 110 to the emergency vehicle 2000. Coupling of the supporting structure 400 with the bottom surface of the base 2020 is temporary, and the supporting structure 400 may be decoupled from the bottom surface of the base 2020, upon accomplishment of the rescue operations. The hollow telescopic member 110 is capable of extending and contracting longitudinally from the base 2020 of the emergency vehicle 2000.

Further, the winch member 120 is configured within the emergency vehicle 2000 on the base 2020 such that the cable 122 may pass through the space door 2010. Further, the cable 122 is capable of being unwound from the winch member 120 to pass through the hollow telescopic member 110. The cable 122 may be unwound from the winch member 120 to extend longitudinally downward through the hollow telescopic member 110 towards the site. Further, the cable 122 may be wound on the winch member 120 to contract longitudinally upward through the hollow telescopic member 110 towards the emergency vehicle 2000. The hoisting system 1000 may include a motor assembly (not shown) to operate the winch member 120 to wind the cable 122 onto the winch member 120, and to unwound the cable 122 from the winch member 120.

According to one embodiment of the present invention, the hoisting system 1000 may include a remote control system (not shown) to operate the hoisting system 1000. More particularly, the remote control system may operate the motor assembly to wind the cable 122 onto the winch member 120, and to unwind the cable 122 from the winch member 120.

The cable 122 of the winch member 120 and the hollow telescopic member 110 are, simultaneously, capable of extending and contracting longitudinally from the base 2020 of the emergency vehicle 2000. The hollow telescopic member 110 may extend from the base 2020 at a position at which a length of the hollow telescopic member 110 permits. Further, the cable 122 is capable of extending at a nearest location to the site through the hollow telescopic member 110.

Furthermore, the deck member 200 is adapted to be coupled to an end portion 122a of the cable 122 unwound from the winch member 120. The deck member 200 is capable of moving downwardly towards the site for supporting the one or more victims thereon, upon unwinding of the cable 122 from the winch member 120. Further, the deck member 200 is capable of moving upwardly towards the emergency vehicle 2000 upon winding of the cable 122 from the winch member 120 for transferring the one or more victims within the emergency vehicle 2000.

According to one embodiment of the present invention, the deck member 200 is a basket, as shown in FIG. 1A. Further, the deck member 200 may be a flat plate. The deck member 200 is large enough to support the one or more victims thereon during rescue operation. According to one embodiment of the present invention, the hoisting system 1000 includes at least one strap, such as a strap 500 configured to the deck member 200 for enabling at least one victim from the one or more victims to grip the strap 500 for preventing themselves from the flood region 3000. The strap 500 may be utilized by the at least one victim, when space of the deck member 200 has been utilized by the one or more victims.

[Note for the inventor: Please confirm our understanding on the strap 500 as described in paragraph [0029].]

Referring now to FIGS. 2A and 2B, front views of a portion of the hoisting system 1000 is illustrated. More particularly, in FIGS. 2A and 2B, a portion of the hollow telescopic member 110 along with a portion of the cable 122 passing there through, and the deck member 200 is illustrated for describing the locking mechanism 300. Reference of FIG. 1A along with FIGS. 2A and 2B will be made herein to describe the locking mechanism 300. The locking mechanism 300 is configured on the at least one retractable arrangement 100, the locking mechanism 300 is capable of locking a spinning of the deck member 200 coupled to the end portion of the cable 122.

More particularly, the hollow telescopic member 110 may extend from the base 2020 to the position at which the length of the hollow telescopic member 110 permits. Thereafter, the cable 122 keeps extending through the hollow telescopic member 110 to the nearest location of the site, so that the one or more victims may get the deck member 200 for supporting thereto on the deck member 200. Such extension and further contraction of the cable 122 may spin the deck member 200. The spinning of the deck may be dangerous for the one or more victims on the deck member 200. The spinning of the deck member 200 may be precluded by the locking mechanism 300. The locking mechanism 300 includes a protruding element 310 and a notch element 320. The protruding element 310 is adapted to be configured to a portion of the cable 122, proximate to the deck member 200 (as shown in FIG. 2A). Further, the notch element 320 is configured to an end portion of the hollow telescopic member 110 for receiving the protruding element 310 (as shown in FIG. 2A). The protruding element 310, when received within the notch element 320, locks the spinning of the deck member 200 coupled to the end portion of the cable 122 (as shown in FIG. 2B).

According to one embodiment of the present invention, a handle (not shown) may be provided on the deck member 200. The handle may be gripped by the one or more victims to secure themselves on the deck member 200.

[Note for the inventor: Please confirm our understanding on the locking mechanism 300, and positions of the protruding element 310 and the notch element 320 of the locking mechanism 300 described in paragraph [0031]. Further, please confirm our understanding on the handle as described in paragraph [0032].]

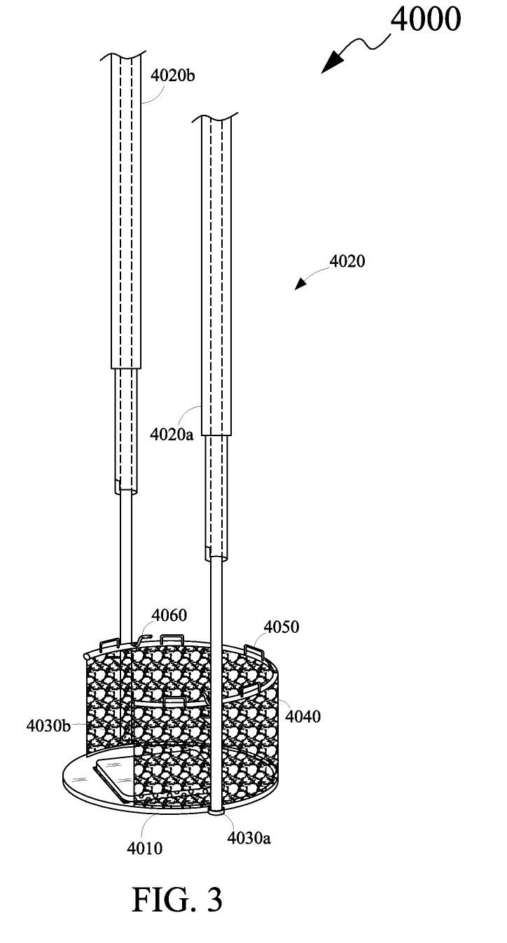

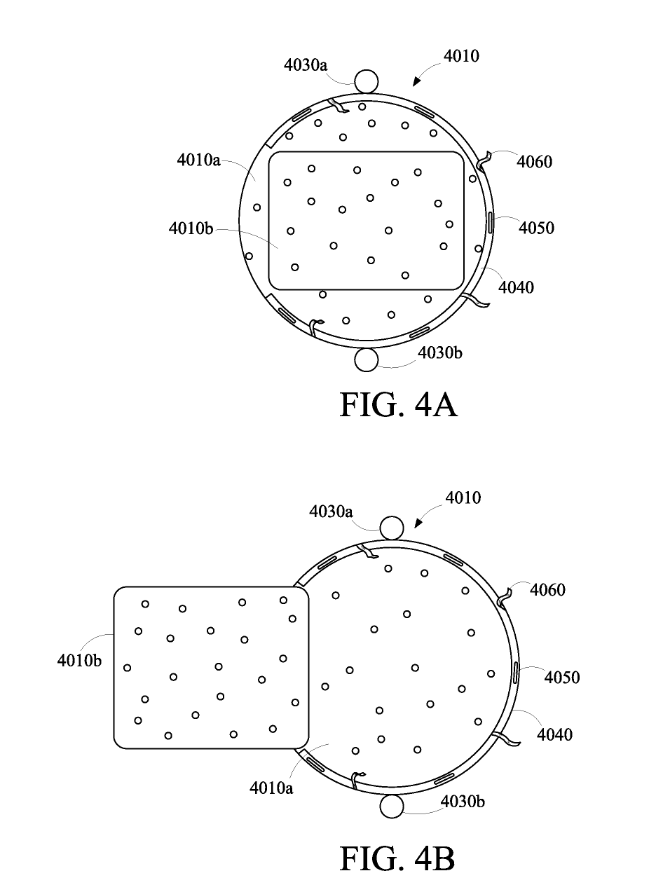

Referring now to FIGS. 3, 4A and 4B, a portion of a hoisting system 4000 according to another exemplary embodiment of the present invention is illustrated. More particularly, FIG. 3 illustrates a perspective view of the portion of the hoisting system 4000, and FIGS. 4A and 4B illustrate top views of a deck member 4010 of the portion of the hoisting system 4000. The portion of the hoisting system 4000 may be configured to an emergency vehicle, such as the emergency vehicle 2000.

As shown in FIG. 3, the portion of the hoisting system 4000 includes at least one retractable arrangement, such as a first retractable arrangement 4020a and a second retractable arrangement 4020b (hereinafter also collectively referred to as retractable arrangements 4020), and the deck member 4010. In FIG. 3, the portion of the hoisting system 4000 is shown to include two retractable arrangements, such as the first retractable arrangement 4020a and the second retractable arrangement 4020b; however, it will be evident to a person skilled in the art to configure a hoisting system having more than two retractable arrangements, such as four retractable arrangements. The retractable arrangements 4020 are similar to the at least one retractable arrangement 100, as described above in conjunction with FIG. 1A. Further, the portion of the hoisting system 4000 includes the deck member 4010 configured to the retractable arrangements 4020 for enabling the deck member 4010 to ascend and descend, as described in conjunction with FIG. 1A. The first retractable arrangement 4020a and the second retractable arrangement 4020b may be, respectively, configured at locations 4030a and 4030b of the deck member 4010. Further, each of retractable arrangement, such as the retractable arrangements 4020, may include a locking mechanism (not shown), such as the locking mechanism 300 including the protruding element 310 and the notch element 320 as described above in conjunction with FIGS. 2A and 2B, for locking a spinning of the deck member 4010.

Further, the portion of the hoisting system 4000 includes a wall member 4040 extending upwardly from a peripheral portion of the deck member 4010. The wall member 4040 may be made out of net or mesh. The wall member 4040 may include handles 4050 and straps 4060 configured thereon. The handles 4050 and the straps 4060 may be gripped by the one or more victims to secure themselves on the deck member 4010. The handles 4050 and the straps 4060 may be six or eight in numbers, depending upon capability of the portion of the housing system 4000 to hold victims on the deck member 4010.

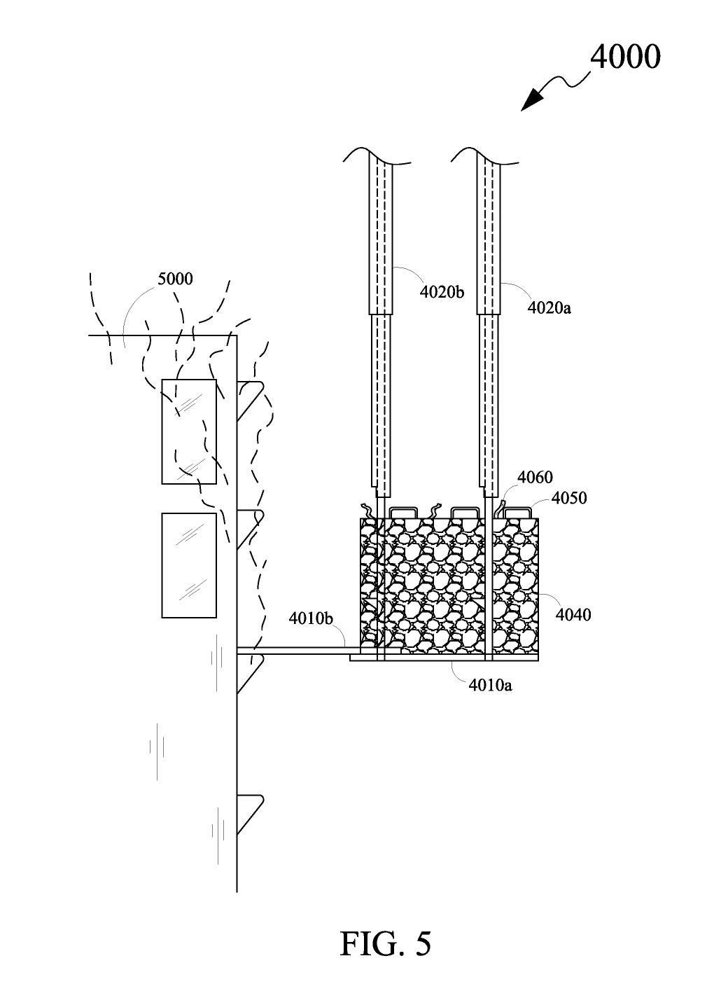

As shown in FIGS. 4A and 4B, the deck member 4010 may includes two flat plates, such as a first flat plate 4010a and a second flat plate 4010b. The second flat plate 4010b is pivotally coupled to the first flat plate 4010a. Further, the locations 4030a and 4030b are located at peripheral portions of the first flat plate 4010a of the deck member 4010, for respectively configuring, the first retractable arrangement 4020a and the second retractable arrangement 4020b. Furthermore, the second flat plate 4010b rests on the first flat plate 4010a, when not utilized. Moreover, the second flat plate 4010b may be pivotally rotated to extend an area covered by the deck member 4010, more particularly, an area covered by the first flat plate 4010a. The extended area formed due to rotating the second flat plate 4010b provides additional space for supporting more number of victims on the deck member 4010. The second flat plate 4010b may also be pivotally rotated to provide a pathway for the one or more victims trapped in a burning building to transfer themselves from the burning building to the portion of the hoisting system 4000 (as shown in FIG. 5) in order to save life thereof. Further, the wall member 4040 extends upwardly from the peripheral portion of the deck member 4010 such that, the second flat plate 4010b may be pivotally rotated without any obstruction due to the wall member 4040.

Referring now to FIG. 5, a side view of the portion of the hoisting system 4000 of FIG. 3 is utilized in a rescue operation on a site, such as a burning building 5000. The portion of the hoisting system 4000 may be configured to an emergency vehicle, such as the emergency vehicle 2000 as described above in conjunction with FIG. 1. The portion of the hoisting system 4000 enables the deck member 4010 to ascend to a position of the burning building 5000 at which a rescue operation is to be performed by the help of the retractable arrangements 4020. Thereafter, the second flat plate 4010b may be pivotally rotated to provide a pathway for the one or more victims trapped in the burning building 5000 to move from the burning building 5000 to the first flat plate 4010a in order to save life thereof. Further, the second flat plate 4010b may be folded, and the deck member 4010 may be descended. Accordingly, the emergency vehicle may dispose the one or more victims at a secure location.

A hoisting system, such as the hoisting system 1000 (as shown in FIG. 1) and the portion of the hoisting system 4000 (as shown in FIG. 3) of the present invention offer the following advantages. The hoisting system is capable of being utilized for rescue operations to save life of one or more victims at a time, trapped in burning buildings, floods, forest fires, and the like. The hoisting system offers rescuing of the trapped victims in an efficient and a successful manner. Further, the hoisting system precludes a spinning of a deck member, such as the deck member 200 and the deck member 4010, which may spin due to undistributed weight and lifting action. Preclusion of the spinning may avoid a falling of a person from the deck member. Moreover, the hoisting system may be powered by a remote control. The hoisting system is sturdy and includes a light weight deck member for lifting victims out of any dangerous terrain. Further, the deck member is secure enough to hold more than one victim in emergency situations.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention

What is claimed is:

1. A hoisting system adapted to be configured on an emergency vehicle for rescue operations to save one or more victims, the hoisting system comprising:
at least one retractable arrangement adapted to be configured on a portion of the emergency vehicle, the at least one retractable arrangement comprising
a hollow telescopic member capable of extending and contracting longitudinally,
a winch member comprising a cable of predetermined length wound thereto, the cable capable of being unwound from the winch member for passing through the hollow telescopic member, wherein the cable is unwound from the winch member to extend longitudinally downward through the hollow telescopic member, and wherein the cable is wound on the winch member to contract longitudinally upward through the hollow telescopic member;
a deck member capable of supporting the one or more victims thereon, the deck member adapted to be coupled to an end portion of the cable unwound from the winch member, wherein the deck member is capable of moving downwardly upon unwinding of the cable, and wherein the deck member is capable of moving upwardly upon winding of the cable; and
a locking mechanism configured on the at least one retractable arrangement, the locking mechanism capable of locking a spinning of the deck member coupled to the end portion of the cable.

2. The hoisting system of claim 1, further comprising a motor assembly for operating the winch member for at least one of winding the cable, and unwinding the cable.

3. The hoisting system of claim 1, further comprising at least one strap configured to the deck member, the at least one strap capable of being gripped by at least one victim of the one or more victims.

4. The hoisting system of claim 1, wherein the locking mechanism comprises
a protruding element adapted to be configured to a portion of the cable, proximate to the deck member; and
a notch element configured to an end portion of the hollow telescopic member for receiving the protruding element for locking the spinning of the deck member coupled to the end portion of the cable.

5. The hoisting system of claim 1, wherein the deck member comprises a first flat plate and a second flat plate pivotally coupled to the first flat plate.

6. The hoisting system of claim 1, wherein the deck member is a flat plate.

7. The hoisting system of claim 1, wherein the deck member is a basket.
